(19) United States
(12) Patent Application Publication
(10) Pub. No.: US 2005/0003866 A1
(43) Pub. Date: Jan. 6, 2005

(54) Method and system for broadcasting short video sequences to a nomad user

(76) Inventors: Christian Bechon, Paris (FR); Pierre Bechon, Cubzac (FR)

Correspondence Address: RATNERPRESTIA, P O BOX 980, VALLEY FORGE, PA, 19482-0980, US

(21) Appl. No.: 10/478,169

(22) PCT Filed: May 17, 2002
(86) PCT No.: PCT/FR02/01683

(30) Foreign Application Priority Data
May 18, 2001 (FR) 01/06572

(51) Int. Cl. H04M 1/00

(52) U.S. Cl. 455/563

(57) ABSTRACT

The invention concerns a method for broadcasting short video sequences to a nomad user. The nomad user is provided with a mobile UMTS terminal (2) connected, via a telecommunication network (6), to a server (3) associated with a database (4). The database (4) comprises short video sequences (5). The method is characterized in that it consists in: identifying the terminal from its identifiers, calculating the terminal display capabilities, taking into account the size of the screen and/or computing capacities and/or image processing means comprised in the terminal, addressing to the server (3) a request for obtaining the video sequences.

The present invention pertains to a process, a system and a device for business broadcasting of short videos related to everyday life and linked with a gestural practice to a wandering user provided with a UMTS mobile telephone terminal.

The problem posed is to distribute, at the request of a user, short video sequence having a practical nature for a broad public, whether in a fixed or a mobile situation. The practical nature of these videos is due to the fact that they have an action requiring a certain “dexterity,” i.e., an action involving a gestural practice.

This problem had only partial solutions up to now:
Hertzian television makes such a broadcasting possible, but it is not known how to do this either at the request of or in a mobile situation of the user;
the broadcasting of such videos is possible on telecommunications networks fixed at a high output, but it does not make it possible to serve the user in a mobile situation.

Moreover, in these two cases, all users connected receive a video in the same format at the same time, which implies a certain homogeneity of the receiving terminal, especially as concerns the display capacities.

Process

The present invention pertains to a process designed to ergonomically broadcast information related to everyday life and linked with a gestural practice to a wandering user, at his request. The wandering user has a UMTS mobile terminal connected, via a UMTS standard telecommunications network, to a server associated with a data base. The data base comprises short video sequence, illustrating the gestural practice. The process according to the present invention comprises the step, for the server, of recognizing the UMTS mobile terminal from identifiers of the UMTS mobile terminal. The process according to the present invention additionally comprises the step, for the server, of computing the display capacities of the UMTS mobile terminal, taking into account the size of the screen and/or the computing capacities and/or image processing means contained by the UMTS mobile terminal. The process according to the present invention additionally comprises the step, for the user, of addressing a request to the server with the aim of obtaining the information related to everyday life and linked with a gestural practice. The request is addressed to the server by means of the UMTS mobile terminal, either by entering the data of the request using ordering means, such as a selection means and/or a pointing means and/or a keyboard associated with the UMTS mobile terminal, or by voice operation. In the case of this embodiment variant, the server comprises voice recognition means for recognizing the voice operation of the user. The process additionally comprises, in response to the request, the step of selecting, depending on the request and on the display capacities of the UMTS terminal, the short video sequence illustrating the gestural practice in the data base associated with the server. The process additionally comprises the step of sending the short video sequence from the server to the UMTS terminal, via the UMTS standard telecommunications network.

Preferably, the process according to the present invention comprises the step, for the server, of processing and adapting the short video sequence as a function of the display capacities of the UMTS terminal.

The process according to the present invention preferably comprises the step, for the server, of adapting the sending rate and/or the short video sequence to the quantity of information actually received by the UMTS terminal, in real time, as processed by the server, taking into account the performances of the telecommunications network, these performances being evaluated, in real time, by the call processor.

According to an embodiment variant, the server, from which information related to everyday life and linked with a gestural practice is broadcast, is operated by a service provider in return for payments. In this case, the process according to the present invention preferably additionally comprises the step, for the server, of performing the operations of posting the payments according to at least one of the two embodiment variants below:

First embodiment variant: Payment through an operator of the UMTS standard telecommunications network. If the user accesses the server through an operator of the UMTS standard telecommunications network and if the service provider has concluded a contract with the telecommunications operator to perform the operations of posting the payments, the process according to the present invention comprises, for the server:
the step of informing the user of the price that the telecommunications operator will add to the contractual device connecting the user to the telecommunications operator,
the step of sending the short video sequence to the terminal of the user after the consent of the user has been received.

Second embodiment variant: Direct payment by the user. If the user accesses the server through an operator of the UMTS telecommunications network and if the service provider has not concluded a contract with this telecommunications operator to perform the operations of posting the payments, the process according to the present invention comprises, for the server:
the step of informing the user of the price that the service provider will invoice to him,
the step of sending the short video sequence to the terminal of the user after the consent of the user has been received.

The process according to the present invention preferably comprises the step of introducing technical and/or business data related to marketable goods and/or services within the short video sequence. In this case, the process preferably additionally comprises the step of offering the user, during the sending of the short video sequence and/or before or after the sending, the possibility of purchasing the goods or services, so that a business relationship may thus be established between the user and the supplier of the marketable goods and/or services. In this case as well, preferably the process according to the present invention additionally comprises the following steps:
the step of informing the user that payments will be due by the user and/or the supplier of the marketable goods and/or services to the service provider, in return for establishing the business relationship,
the step of posting the payments due by the user and/or the supplier of marketable goods and/or services to the service provider in return for establishing the business relationship.

Also in these cases, the process according to the present invention preferably additionally comprises the following steps:
the step of offering to the user the possibility of refusing the sending of the short video sequence, comprising the establishing of a business relationship between the user and the supplier,
the step of sending to the terminal of the user, after his consent has been received, the short video sequence, comprising the establishing of a business relationship between the user and the supplier.

To introduce technical and/or business data related to goods and/or services within the short video sequence, the process according to the present invention employs at least one of the methods selected from among the following group of methods:
(a) the method of superimposing images or a continuous set of images of a promotional or advertising nature in the form of visual and/or audio banners on the short video sequence,
(b) the method of inserting one or more sequence in the short video sequence that only contain images or a continuous set of images of a promotional or advertising nature with or without audio comments,
(c) the method of showing or demonstrating the use of goods or services of a marketable nature by the images with audio comments or by a continuous set of images with audio comments in the short video sequence,
(d) the method of inserting the trademark, logo, a marked product or any distinctive sign of a marketable product and/or service within the short video sequence in a clearly visible and/or audible manner.

According to the present invention, the duration of the short video sequence is preferably at the most equal to 9 minutes.

System

The present invention also pertains to a system designed to make it possible to broadcast, in an ergonomic manner, information related to everyday life and linked with a gestural practice in the form of short video sequence illustrating this gestural practice to a wandering user, at his request. The system according to the present invention comprises a UMTS mobile terminal used by the user. The system according to the present invention additionally comprises a server that comprises a call processor and a data base. The data base comprises short video sequence illustrating the gestural practice selected.

The system of the present invention additionally comprises a UMTS gateway connecting the server, via a UMTS standard telecommunications network, to the UMTS mobile terminal. Thanks to this combination of means, the server can receive and/or send data to the UMTS mobile terminal.

The call processor comprises identification means in real time for recognizing the UMTS mobile terminal from identifiers of the UMTS mobile terminal. The call processor additionally comprises computing means for computing the display capacities of the UMTS mobile terminal, by taking into account the size of the screen and/or the computing capacities and/or image processing means contained in the UMTS mobile terminal. The call processor additionally comprises voice recognition means.

The UMTS mobile terminal comprises ordering means that can be actuated by the user for addressing a request to the server with the aim of obtaining information related to everyday life and linked with a gestural practice. The ordering means that can be actuated by the user for addressing the request comprise data entering means, and in particular, a selection means and/or a pointing means and/or a keyboard, and/or voice operation means. In this case, the server comprises voice recognition means for recognizing the voice operation.

The server additionally comprises selection means for selecting, depending on said request and the display capacities of the UMTS terminal, the short video sequence illustrating the selected gestural practice in the data base associated with the server. The server additionally comprises sending means for sending the short video sequence from the server to the UMTS terminal via the UMTS standard communications network.

Preferably, the server consists of a plurality of secondary server that are identical, distinct, and connected either to one another or to a central server.

Preferably, the call processor comprises computing means for computing and adapting the short video sequence as a function of the display capacities on the UMTS terminal.

Preferably, the call processor comprises computing means for adapting, in real time, the rate of sending and/or the computing and/or selection of the short video sequence as a function of the quantity of information received by the UMTS terminal, taking into account the performances of the telecommunications network. The performances are evaluated, in real time, by the call processor.

According to an embodiment variant, the server, from which the information that is related to everyday life and linked with a gestural practice is broadcast, is operated by a service provider in return for payments. In the case of this variant, the call processor of the server additionally comprises computing means for processing the payments according to at least one of the two variants below:
First variant: Payment through an operator of the UMTS standard telecommunications network. If the user accesses the server through an operator of the UMTS standard telecommunications network and if the service provider has concluded a contract with the telecommunications operator, the server additionally comprises computing means for supplying information, in real time, to the user, including the price that the telecommunications operator will add to the contractual device connecting the user to the telecommunications operator. In the case of this first variant, the server additionally comprises sending means for sending the short video sequence to the terminal of the user after the consent of the user has been received.
Second variant: Direct payment by the user. If the user accesses the server through an operator of the UMTS standard telecommunications network and if the service provider has not concluded a contract with the telecommunications operator, the server additionally comprises computing means for supplying information, in real time, to the user, including the price that the service provider will invoice to the user. In the case of this variant, the server additionally comprises sending means for sending the short video sequence to the terminal of the user after the consent of the user has been received.

Preferably, the system according to the present invention additionally comprises image processing means for introducing technical and/or business data related to marketable goods and/or services within short video sequence. In this case, the system preferably additionally comprises interactive data processing means, using the UMTS standard telecommunications network to offer, via the UMTS mobile terminal, to the user, during the sending of the short video sequence and/or before or after the sending, the possibility of purchasing the goods or services. Thanks to this combination of means, a business relationship can be established between the user and the supplier of the marketable goods and/or services. Also in this case, the system preferably additionally comprises data processing means for informing, via the UMTS mobile terminal, the user that the payments will be due by the user and/or the supplier of the marketable goods and/or services to the service provider, in return for establishing the business relationship. Also in this case, the system preferably additionally comprises computing means for posting the payments due by the user and/or the supplier of the marketable goods and/or services to the service provider in return for establishing the business relationship.

Preferably, the UMTS mobile terminal additionally comprises ordering means that can be actuated by the user to refuse the sending of short video sequence, comprising the establishing of a business relationship between the user and the supplier. The server preferably additionally comprises sending means for sending the short video sequence to the terminal of the user, after his consent has been received, comprising the establishing of a business relationship between the user and the supplier.

In the case of an embodiment variant the image processing means introduce technical and/or business data related to the goods and/or services within short video sequence. In the case of this variant, the system employs at least one of the means selected from among the following group of means:
(a) superimposing means for superimposing images or a continuous set of images of a promotional or advertising nature in the form of visual and/or audio banners on the short video sequence,
(b) insertion means for inserting one or more sequence in the short video sequence that only contain images or a continuous set of images of a promotional or advertising nature with or without audio comments,
(c) showing means for showing or demonstrating the use of goods or services of a marketable nature by the images with audio comments or by a continuous set of images with audio comments in the short video sequence,
(d) insertion means for inserting the trademark, logo, a marked product or any distinctive sign of a marketable product and/or service within the short video sequence in a clearly visible and/or audible manner.

The duration of the short video sequence is preferably at the most equal to 9 minutes.

Server

The present invention also pertains to a server designed to broadcast information related to everyday life and linked with a gestural practice in the form of short video sequence illustrating the gestural practice to a wandering user, at his request, in an ergonomic manner. The wandering user has a UMTS mobile terminal. The server comprises a call processor and a data base. The data base comprises short video sequence illustrating the gestural practice. The server is connected, via a UMTS standard telecommunications network, to the UMTS mobile terminal. Thanks to this combination of means, the server is able to receive and/or send data to the UMTS mobile terminal. The server according to the present invention additionally comprises identification means to recognize the UMTS mobile terminal from identifiers of the UMTS mobile terminal. The server according to the present invention additionally comprises computing means for computing the display capacities of the UMTS mobile terminal, taking into account the size of the screen and/or the computing capacities and/or image processing means contained in the UMTS mobile terminal. The server according to the present invention additionally comprises voice recognition means. The server according to the present invention additionally comprises receiving means for receiving from this UMTS mobile terminal a request sent by the user. The aim of this request is to obtain information related to everyday life and linked with a gestural practice. This request was formulated by the user by entering data, and especially with a selection means and/or a pointing means and/or a keyboard, associated with the UMTS mobile terminal, and/or by using a voice operation. If the request is formulated in the form of a voice operation, the server additionally comprises voice recognition means to recognize this voice operation. The server according to the present invention additionally comprises data processing means for processing this request. The server according to the present invention additionally comprises selection means for selecting the short video sequence illustrating the gestural practice in the data base associated with the server depending on this request and on the display capacities of the UMTS terminal. The server according to the present invention additionally comprises sending means for sending the short video sequence from the server to the UMTS mobile terminal, via the UMTS standard communications network.

Preferably, the server consists of a plurality of secondary server that are identical, distinct, and connected either to one another or to a central server.

Preferably, the call processor comprises computing means for computing and adapting the short video sequence as a function of the display capacities on the UMTS terminal.

Preferably, the call processor comprises computing means for adapting, in real time, the rate of sending and/or computing and/or selection of short video sequence as a function of the quantity of information received by the UMTS terminal, taking into account the performances of the telecommunications network, the performances being evaluated, in real time, by the call processor.

In an embodiment variant, the server, from which the information related to everyday life and linked with a gestural practice is broadcast, is operated by a service provider in return for payments. In this case, the server additionally comprises computing means for processing the payments according to at least one of the two variants below:
First variant: Payment through an operator of the UMTS standard telecommunications network. If the user accesses the server through an operator of the UMTS standard telecommunications network and if the service provider has concluded a contract with the telecommunications operator, the server additionally comprises computing means for supplying information to the user, in real time, including the price that the telecommunications operator will add to the contractual device connecting the user to the telecommunications operator. In the case of this first embodiment variant, the server additionally comprises sending means for sending the short video sequence to the terminal of the user after the consent of the user has been received.
Second variant: Direct payment by the user. If the user accesses the server through an operator of the UMTS standard telecommunications network and if the service provider has not concluded a contract with the telecommunications operator, the server additionally comprises computing means for supplying information, in real time, to the user, including the price that the service provider will invoice to the user. In the case of this second embodiment variant, the server additionally comprises sending means for sending the short video sequence to the terminal of the user after the consent of the user has been received.

Preferably, the server additionally comprises image processing means for introducing technical and/or business data related to marketable goods and/or services within short video sequence. In this case, the server additionally comprises interactive image means, using the UMTS standard telecommunications network to offer the possibility of purchasing the goods or services via the UMTS mobile terminal, to the user, during the sending of the short video sequence and/or before or after the sending. Thanks to this combination of means, a business relationship can be established between the user and the supplier of the marketable goods and/or services. In this case, the server additionally comprises computing means for informing the user, in real time, via the UMTS terminal, that payments will be due by the user and/or the supplier of the marketable goods and/or services to the service provider, in return for establishing the business relationship. In this case, the server additionally comprises computing means for posting the payments due by the user and/or the supplier of the marketable goods and/or services to the service provider in return for establishing a business relationship.

Preferably, in order to process the case in which the user refuses the sending of short video sequence, comprising the establishing of a business relationship between the user and the supplier, the server additionally comprises refusal decision processing means. These processing means comprise especially voice recognition means. From this perspective also, the server additionally comprises sending means for sending the short video sequence to the terminal of the user after the consent of the user has been received, comprising the establishing of a business relationship between the user and the supplier.

The image processing means for introducing technical and/or business data related to goods and/or services within short video sequence preferably employ at least one of the means selected from among the following group of means:
(a) superimposing means for superimposing images or a continuous set of images of a promotional or advertising nature in the form of visual and/or audio banners on the short video sequence,
(b) insertion means for inserting one or more sequence in the short video sequence that only contain images or a continuous set of images of a promotional or advertising nature with or without audio comments,
(c) showing means for showing or demonstrating the use of goods or services of a marketable nature by the images with audio comments or by a continuous set of images with audio comments in the short video sequence,
(d) insertion means for inserting the trademark, logo, a marked product or any distinctive sign of a marketable product and/or service within the short video sequence in a clearly visible and/or audible manner.

The duration of the short video sequence is preferably at the most equal to 9 minutes.

The present invention indicates an innovation over the prior art because, retaining a solution by a high-output Hertzian network (UMTS standard networks), it makes it possible to serve the users in a fixed or mobile situation. The present invention also indicates an innovation over the prior art because, retaining a solution in which the system computes and adapts the video to be sent as a function of the display and image processing capacities (availability of decompression, decoding or vectorial video interpretation algorithms) of the calling terminal, it makes it possible to serve very heterogeneous terminals. The present invention has the advantage of making it possible to address all the terminals connected to the UMTS standard telephone networks, regardless of their screen size and their “intelligence.” The present invention additionally makes it possible to optimize at the minimum the quantity of information sent to the calling terminal and therefore to reduce the costs for the user.

Other features and advantages of the present invention shall become evident from reading the description of embodiment variants of the present invention given by way of indicative and non-limiting examples, and from:

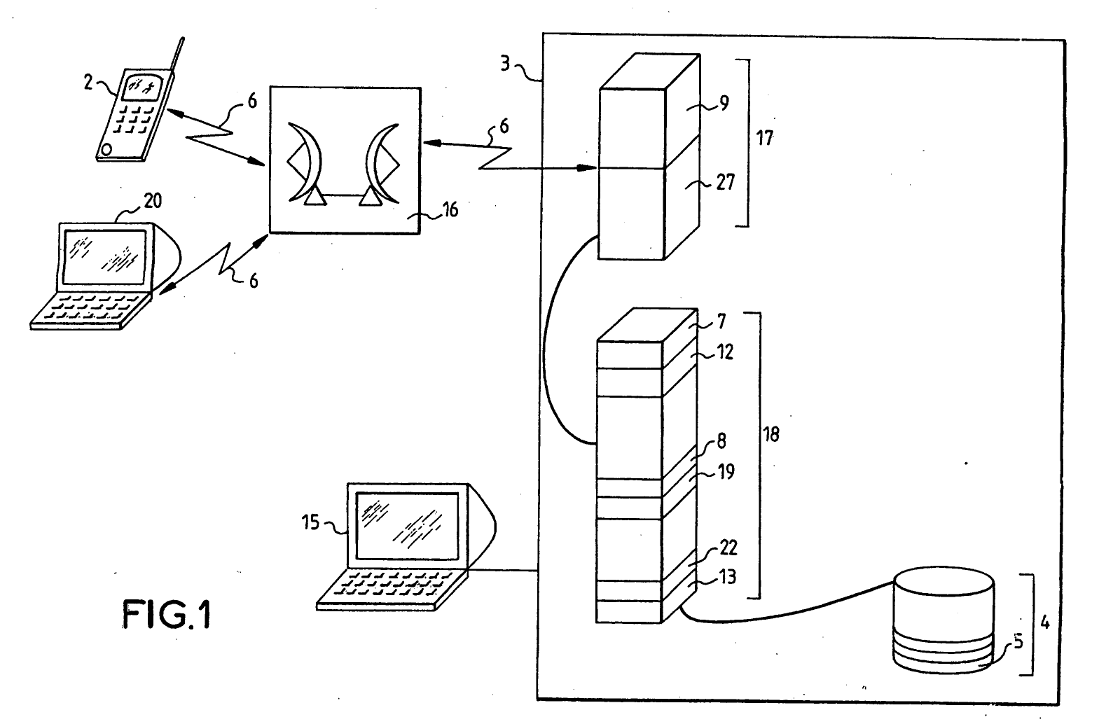

FIG. 1, which shows an overall view of the system and process according to the present invention;

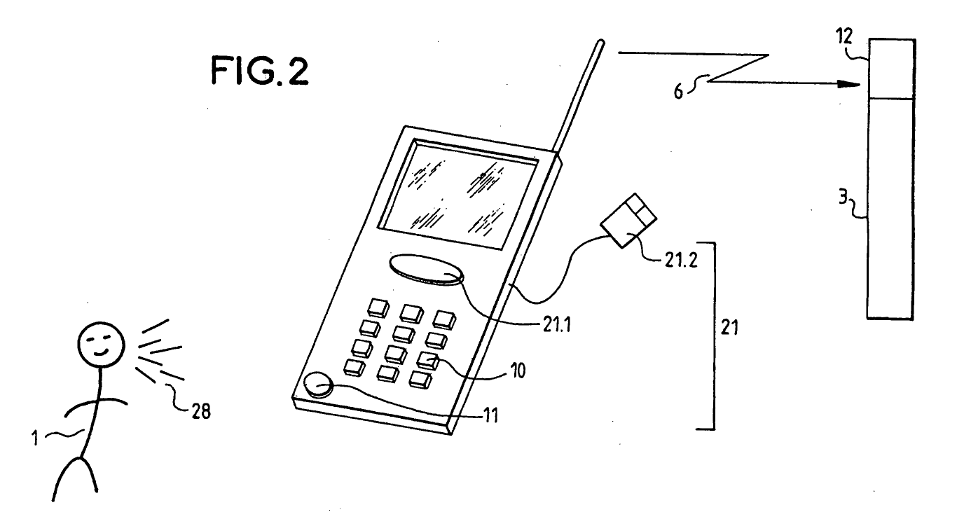

FIG. 2, which shows the possible means of the system, by which the user 1 is able to put in an order;

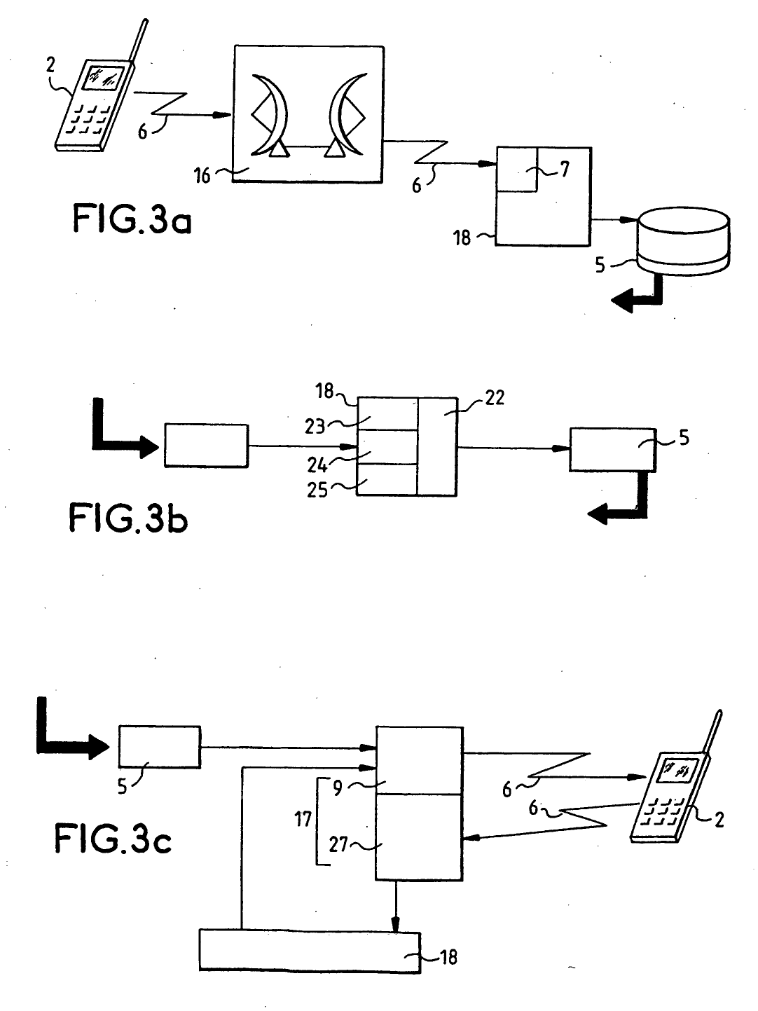

FIG. 3, which shows the process for selecting and preparing the short video sequence 5;

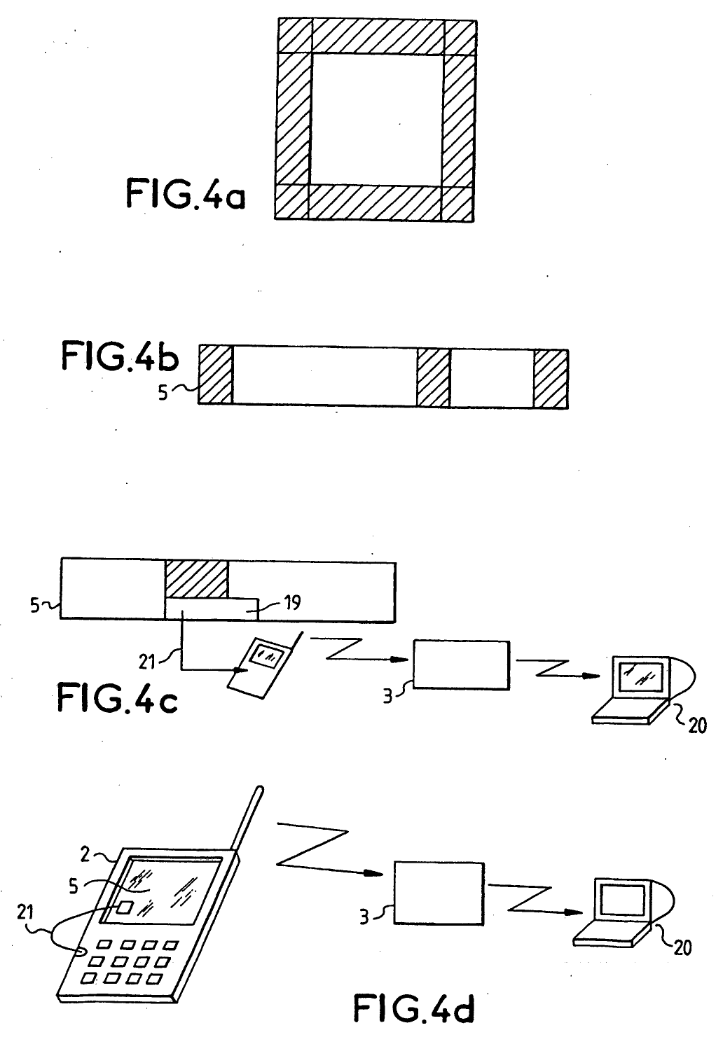

FIG. 4, which shows the different processes for inserting messages of an advertising nature in the short video sequence 5.

FIG. 1, which shows an overall view of the system and process according to the present invention, shall now be described.

The system makes it possible to order, from a UMTS terminal 2, a short video sequence S, illustrating a gestural practice. The order of the user is forwarded to a server 3 by a UMTS standard telecommunications network 6 operated by a telecommunications operator 16.

The server 3 comprises:
a UMTS gateway 17, which receives and sends the UMTS standard information thanks to its sending means 9 and its receiving means 27,
a call processor 18 that, for managing the user and his requests, contains voice recognition means 12, means for recognizing and identifying the UMTS terminal 7 and means 8 for computing the payments and display capacities, as well as, for the management of images, means for selecting videos 13, m-business interactive processing means 19 and image processing means 22,
a data base 4 that comprises short video sequence 5 illustrating the gestural practices, with these short video sequence 5 being prepared by the call processor 18 by means of image processing means 22.

Upon receipt of the order, the call processor 18 questions the UMTS terminal 2 to know its identification thanks to its identification means 7 and to know its material configuration, especially the size of its screen, as well as its continuous image processing and display capacities.

The call processor 18 selects the short video sequence 5 in the data base 4 corresponding to the order of the user, taking into account the display capacities of the UMTS terminal 2 thanks to its computing means 8.

The call processor 18 computes the sale price of the short video sequence 5 corresponding to his order to the user 1. The user 1 is informed of this price. After the consent of the user 1 has been received, the service provider 15, who operates the server 3, invoices the user 1, either by invoicing the operator of the telecommunications network 16, who will re-invoice the user 1, if the operator of the telecommunications network 16 and the service provider 15 have concluded a contract between them for this purpose, or directly.

The call processor 18 optionally reprocesses this short video sequence 5 in real time in order to put it in a format compatible with the UMTS terminal 2, on the one hand, and, on the other hand, to optimize the volume of data to be transmitted. The call processor 18 may also adjust the rate of transmission of this short video sequence 5 in real time to the rate of the UMTS standard telecommunications network as measured by the server 3.

The call processor 18 then sends the short video sequence 5 ordered to the UMTS terminal 2 of the user 1 by means of the UMTS gateway 17 and then the UMTS standard telecommunications network 6.

If the user 1 chooses to activate a proposed link to business sites (m-business) 20, the call processor 18 executes this order thanks to the UMTS standard telecommunications network 6 and remembers it for a possible customer invoicing.

FIG. 2 will now be described, which shows the possible means of the system by which the user 1 is able to put in an order from his UMTS terminal 2 by means of ordering means 21, i.e.:
entering the order by means of a keyboard 10;
entering the order by means of a navigator button 21.1 or a pointing selector (mouse type) 21.2;
entering the voice operation 11 by means of a voice command 28, which, received by the microphone of the UMTS terminal 2, is sent to the server 3 for recognition and interpretation through the UMTS standard telecommunications network 6.

The high rates of the UMTS networks authorize the voice recognition means 12 of the terminal 2 to send to the server 3.

FIG. 3, which shows the process for selecting and preparing the short video sequence 5, will now be described. The process comprises three steps, which are the subjects of FIGS. 3a, 3b and 3c.

a) The Selection of the Video Sequence (FIG. 3a)

The first step of the process designed to select the short video sequence 5 requested in the different formats thereof, formats stored in the data base 4, performs the following computation:
during the connection of the calling UMTS terminal 2, the call processor 18, by means of its means 7 for identifying the terminals, questions the calling UMTS terminal 2 about its physical display means (screen size and number of colors) and about its display software means (capacity for processing images within the terminal and display and/or decompression software);
the call processor 18 takes into account the smallest of the following rates as the “passing” rate: either the nominal rate of the UMTS standard telecommunications network 6, i.e., that which is provided by the operator 16 of the UMTS standard telecommunications network, or the UMTS standard receiving rate of the calling UMTS terminal 2 provided by its designer and known thanks to its identification;
the call processor 18 selects the format of the short video sequence 5 requested thanks to the video selection means 13 as a function of the previous data according to the following method: its resolution, its video mode and its compression format depend on the display capacities of the UMTS terminal 2; its rate of compression depends on the “passing” rate, so that the volume to be transmitted is always less than the “passing” rate times 9 minutes at the most.

b) The Adaptation of the Video Sequence (FIG. 3b)

The second computation of the call processor 18, starting from the computations of the first step, adapts the selected short video sequence 5, in real time, in order to bring the “passing” rate as close as possible to the speed of displaying the image on the UMTS terminal 2, the selected short video sequence 5 being subjected to this, before sending, and thanks to its video processing means 22, processings, such as:
the adaptation of the video to the resolution of the UMTS terminal 2;
the variation of the rate of compression of the video in all or part.

The call processor 18 inserts one or more advertising messages thanks to its means 23 for superimposing, to its means 24 for inserting and to its means 25 for showing this message or these messages in the short video sequence 5. This insertion of advertising messages may take place in real time or prior to the request.

c) The Adaptation to the Rate of Broadcasting (FIG. 3c)

The third computation adapts, in real time, the sending rate of the sending means 9 of the UMTS gateway 17 of the short video sequence 5 selected and prepared according to a) and b) to the apparent actual rate of the UMTS terminal 2/UMTS standard telecommunications network pair. This apparent actual rate is measured by the rate of occupation of the memory associated with the UMTS gateway 17. The adaptation is done by varying the rate of compression of the short video sequence 5 selected and prepared according to a) and b).

All in all, the call processor 18 computes the sending rate of the UMTS gateway 17, as well as the video, taking into account the display capacities and “the intelligence” of the calling UMTS terminal 2.

FIG. 4, which shows the different processes of inserting messages of an advertising nature in the short video sequence 5, whether or not in real time, will now be described.

a) The Superimposing Mode (FIG. 4a)

FIG. 4a shows a screen view and specifies the different sites for inserting messages of an advertising nature. The superimposing mode superimposes these messages, during all or part of the broadcast of the short video sequence 5, on at least one of the four hatched banners shown in FIG. 4a. These banners may be visual and/or audio and composed of fixed images or continuous sets of images of a promotional or advertising nature.

b) The Mode of Inserting Advertising Screens (FIG. 4b)

FIG. 4b shows the running of a short video sequence 5. The mode of inserting advertising screens inserts, in full screen, during the broadcast of the short video sequence 5, one or more video advertising sequence either during the short video sequence 5, or before its beginning, or after its end, these sequence containing either fixed images or a continuous set of images of a promotional or advertising nature, each with or without audio comments. These different modes of inserting advertising screens are shown partly hatched in FIG. 4b.

c) The Mode of Showing a Product for Remote Purchasing (FIG. 4c)

FIG. 4c shows the running of the short video sequence 5. The mode of showing a product for remote purchasing shows, in full screen, within the short video sequence 5, a marketable good or product by fixed images with audio comments or a continuous set of images with audio comments. During or after the showing, a part of the video sequence may propose a link to a business site selling this good or service. This link can be actuated thanks to the ordering means 21 of the UMTS terminal 2, it is received by the server 3 who puts the UMTS terminal 2 in contact with the business site (m-business) 20 in question.

d) The Mode of Inserting by Superimposing on an Object (FIG. 4d)

FIG. 4d shows a view of the UMTS terminal 2. The mode of inserting by superimposing on an object makes the trademark, logo, a marked product or any distinctive sign of a marketable good and/or service appear within the short video sequence 5 and within the screen in a clearly visible and/or audible manner. This trademark, logo, marked product or distinctive sign of a marketable good and/or service may propose a link to a business site selling this good or service. This link can be actuated thanks to the ordering means 21 of the UMTS terminal 2, it is received by the server 3, who puts the UMTS terminal 2 in contact with the business site (m-business) 20 in question. This superimposing the trademark, logo, marked product or distinctive sign of a product accompanies the superimposed object throughout the short video sequence 5.

Synthesis

The present invention takes all the advantages of the transmission rates of third-generation telephone networks as determined by the European Union (UMTS standards), offering a service of ultrashort film lengths concerning daily life, whether it be sports, entertainment, gardening, do-it-yourself, cooking, health/beauty, practical life, etc., these ultrashort film lengths having an action requiring a certain “dexterity” or good hand movements.

Besides its globality, the present invention indicates innovation on the following points:
the process is innovative in that the proposed system computes and adapts the video to be sent as a function of the display and image processing capacities (availability of decompression, decoding or vectorial video interpretation algorithms) of the calling terminal. This is very different from the Hertzian broadcasting or, to a lesser extent, from internet video (“streaming”) because, in these cases, this broadcasting is done in a fixed format at the time of the sending. The image of the video sent is thus the same for all receiving terminals. The advantage of this process is that it thus makes it possible to address all the terminals connected to the UMTS standard telephone networks, regardless of their screen size and their “intelligence.” This process additionally makes it possible to optimize at the minimum the quantity of information sent to the calling terminal and therefore to reduce the costs for the user;
the process is innovative in that it comprises a system of payment to the act with or without payback from the telephone operator after receiving the acceptance of the user, which distinguishes him both from the minitel or from the internet;
the process is innovative in that it provides a form of advertising, included by the image processing means, as part of the video broadcast and not only in the usual forms of advertising on television or on the internet, i.e., in the form of banners, advertising sequence or demonstration of products;
the system is innovative in that it utilizes the capacity of the high-output networks to send a voice operation of the user, to recognize it thanks to its own means and to perform it. The fact that the voice recognition system is housed in the server and not in the portable terminal as for the GSM (Groupe Spécial Mobile standard portable telephones.

1. Process designed to broadcast information related to everyday life and linked with a gestural practice ergonomically to a wandering user, and at his request; the wandering user having a UMTS mobile terminal connected, via a UMTS standard telecommunications network, to a server associated with a data base; said data base comprising short video sequences illustrating the gestural practice;
the process comprising the following steps:
the step, for the server, recognizing the UMTS mobile terminal from identifiers of the UMTS mobile terminal,
the step, for the server, computing the display capacities of the UMTS mobile terminal, taking into account the size of the screen and/or computing capacities and/or image processing means contained by the UMTS mobile terminal,
the step, for the user, of addressing a request to the server with the aim of obtaining the information related to everyday life and linked with a gestural practice;
the request being addressed to the server by means of the UMTS mobile terminal,
either by entering the data of the request by means of said ordering means, selected from a group consisting of selection means, a pointing means and a keyboard, associated with the UMTS mobile terminal, or by a voice operation, the server comprising voice recognition means to recognize the voice operation of the user;
the process additionally comprising the following steps, in response to the request:
the step of selecting the short video sequences illustrating said gestural practice in the data base associated with the server as a function of the request and the display capacities of the UMTS terminal;
the step of sending the short video sequences from the server to the UMTS terminal via the UMTS standard telecommunications network.

2. Process in accordance with claim 1, the process additionally comprising:
the step, for the server, of computing and adapting said short video sequences as a function of the display capacities on the UMTS terminal.

3. Process in accordance with any of claims 1 or 2, the process additionally comprising:
the step, for the server, of adapting, in real time, at least one of a sending rate a computing and a selection of the short video sequences to a quantity of information actually received by the UMTS terminal as computed by the server, taking into account performances of the telecommunications network; performances being evaluated, in real time, by a call processor.

4. Process in accordance with any of the claims 1 or 2; the server, from which the information related to everyday life and linked with a gestural practice is broadcast, being operated by a service provider in return for payments;
the process additionally comprising the step, for the server, of carrying out the operations of posting the payments according to at least one of the two cases below;
(a) payment through an operator of the UMTS standard telecommunications network
if the user accesses the server through an operator of the UMTS standard telecommunications network and if the service provider has concluded a contract with the telecommunications operator,
the step of carrying out the operations of posting the payments comprises, for the server:
the step of informing the user of the price that the telecommunications operator will add to the contractual device connecting the user to the telecommunications operator,
the step of sending the short video sequence to the terminal of the user after the consent of the user has been received.
(b) direct payment by the user
if the user accesses the server through an operator of the UMTS standard telecommunications network and if the service provider has not concluded a contract with the telecommunications operator
the step of carrying out the operations of posting the payments comprises, for the server:
the step of informing the user of the price that the service provider will invoice to the user,
the step of sending the short video sequence to the terminal of the user after the consent of the user has been received.

5. Process in accordance with any of the claims 1 or 2; the process additionally comprising the step of introducing technical and/or business data related to marketable goods and/or services within the short video sequences.

6. Process in accordance with claim 5; the process additionally comprising:
the step of offering to the user, during the sending of said short video sequences and/or before or after the sending, the possibility of purchasing the goods or services, such that a business relationship may thus be established between the user and the supplier of the marketable goods and/or services.

7. Process in accordance with claim 6; said process additionally comprising the following steps:
the step of informing the user that payments will be due by the user and/or the supplier of the marketable goods and/or services to the service provider, in return for the establishing of a business relationship,
the step of posting the payments due by the user and/or the supplier of the marketable goods and/or services to the service provider in return for the establishing of a business relationship.

8. Process in accordance with claim 6; said process additionally comprising the following steps:
the step of offering to the user the possibility of refusing the sending of the short video sequences, comprising the establishing of a business relationship between the user and the supplier,
the step of sending the short video sequence to the terminal of the user after the consent of the user has been received, comprising the establishing of a business relationship between the user and the supplier.

9. Process in accordance with claim 5; the process being such that the step of introducing technical and/or business data related to goods and/or services within the short video sequences uses at least one of the methods selected from among the following group of methods:
(a) the method of superimposing images or a continuous set of images of a promotional or advertising nature in the form of visual and/or audio banners on the short video sequence,
(b) the method of inserting one or more sequence in the short video sequence that only contain images or a continuous set of images of a promotional or advertising nature with or without audio comments,
(c) the method of showing or demonstrating the use of goods or services of a marketable nature by the images with audio comments or by a continuous set of images with audio comments in the short video sequence,
(d) the method of inserting the trademark, logo, a marked product or any distinctive sign of a marketable product and/or service within the short video sequence in a clearly visible and/or audible manner.

10. Process in accordance with claims 1 or 2; the process being such that the duration of the short video sequences is at the most equal to 9 minutes.

11. A system designed to broadcast information related to everyday life and linked with a gestural practice in the form of said short video sequences illustrating the gestural practice to a wandering user, and at his request, in an ergonomic manner;
the system comprising:
a UMTS mobile terminal used by the user,
a server comprising:
a call processor
a data base;
the data base comprising said short video sequences (5) illustrating the gestural practice;
the system additionally comprising:
a UMTS gateway connecting the server, via a UMTS standard telecommunications network, to the UMTS mobile terminal, so that the server can receive and/or send data to the UMTS mobile terminal;
the call processors comprising:
identification means operating in real time for recognizing the UMTS mobile terminal from identifiers of the UMTS mobile terminal,
computing means for computing the display capacities of the UMTS mobile terminal, taking into account the size of the screen and/or the computing capacities and/or image processing means contained in the UMTS mobile terminal,
voice recognition means,
the UMTS mobile terminal comprising the ordering means, which can be actuated by the user, to address a request to the server with the aim of obtaining the information related to everyday life and linked with a gestural practice;
the ordering means that can be actuated by the user for addressing the request comprising:
data entering means, selected from a group including a selection means, a pointing means, a keyboard, voice operation means, the server comprising voice recognition means for recognizing a voice operation;
the server additionally comprising:
selection means for selecting the short video sequences illustrating the gestural practice in the data base associated with the server as a function of the request and the display capacities of the UMTS terminal,
sending means for sending the short video sequences from the server to the UMTS terminal via the UMTS standard communications network.

12. System in accordance with claim 11; the server being composed of a plurality of secondary servers, which are identical, distinct, and connected either to one another or to a central server.

13. System in accordance with any of the claims 11 or 12; the call processor comprising said computing means for computing and adapting the short video sequences as a function of the display capacities on the UMTS terminal.

14. System in accordance with any of the claims 11 or 12; the call processor comprising said computing means for adapting, in real time, the sending rate and/or the computing and/or selection of the short video sequences as a function of the quantity of information received by the UMTS terminal, taking into account the performances of the telecommunications network; the performances being evaluated, in real time, by the call processor.

15. System in accordance with any of the claims 11 or 12; the server, from which the information related to everyday life and linked with a gestural practice is broadcast, being operated by a service provider in return for payments;
the server additionally comprising, by its said call processor, said computing means for processing the payments according to at least one of the two cases below;
(a) payment through an operator of the UMTS standard telecommunications network
if the user accesses the server through an operator of the UMTS standard telecommunications network and if the service provider has concluded a contract with the telecommunications operator,
the server additionally comprises:
computing means for supplying information, in real time, to the user, including the price that the telecommunications operator will add to the contractual device connecting the user to the telecommunications operator,
sending means for sending the short video sequence to the terminal of the user after the consent of the user has been received.
b) direct payment by the user
if the user accesses the server through an operator of the UMTS standard telecommunications network and if the service provider has not concluded a contract with the telecommunications operator,
the server additionally comprises:
computing means for supplying information, in real time, to the user, including the price that the service provider will invoice to the user,
sending means for sending the short video sequence to the terminal of the user after the consent of the user has been received.

16. System in accordance with any of the claims 11 or 12; the system additionally comprising said image processing means for introducing technical and/or business data related to marketable goods and/or services within the short video sequences.

17. System in accordance with claim 16; the system additionally comprising:
interactive data processing means, using the UMTS telecommunications network to offer, via the UMTS mobile terminal, to the user, during the sending of the short video sequences and/or before or after the sending, the possibility of purchasing the goods or services, so that a business relationship may thus be established between the user and the supplier of the marketable goods and/or services.

18. System in accordance with claim 17; the system additionally comprising:
data processing means for informing the user, via the UMTS mobile terminal, that the payments will be due by the user and/or the supplier of the marketable goods and/or services to the service provider, in return for the establishing of a business relationship, and
computing means for posting the payments due by the user and/or the supplier of the marketable goods and/or services to the service provider in return for establishing the business relationship.

19. System in accordance with any of the claim 17; the system being such that:
the UMTS mobile terminal additionally comprising the ordering means that can be actuated by the user for refusing the sending of the short video sequences, comprising the establishing of a business relationship between the user and the supplier,
the server additionally comprising the sending means for sending the short video sequence to the terminal of the user after the consent of the user has been received, comprising the establishing of a business relationship between the user and the supplier.

20. System in accordance with any of the claims 17, such that the image processing means for introducing technical and/or business data related to goods and/or services within said short video sequences uses at least one of the means selected from among the following group of means:
(a) superimposing means for superimposing images or a continuous set of images of a promotional or advertising nature in the form of visual and/or audio banners on the short video sequence,
(b) insertion means for inserting one or more sequence in the short video sequence that only contain images or a continuous set of images of a promotional or advertising nature with or without audio comments,
(c) showing means for showing or demonstrating the use of goods or services of a marketable nature by the images with audio comments or by a continuous set of images with audio comments in the short video sequence,
(d) insertion means for inserting the trademark, logo, a marked product or any distinctive sign of a marketable product and/or service within the short video sequence in a clearly visible and audible manner.

21. System in accordance with any of the claims 11 or 12, such that the duration of the short video sequences is at the most equal to 9 minutes.

22. A server designed to broadcast information related to everyday life and linked with a gestural practice in the form of said short video sequences illustrating the gestural practice to a wandering user, and at his request, in an ergonomic manner;
the wandering user having a UMTS mobile terminal;
the server comprising:
a call processor,
a data base;
the data base comprising said short video sequences illustrating the gestural practice;
the server being connected, via a UMTS standard telecommunications network, to the UMTS mobile terminal; so that the server can receive and/or send data to the UMTS mobile terminal;
the server comprising:
identification means for recognizing the UMTS mobile terminal from identifiers of the UMTS mobile terminal,
computing means for computing the display capacities of the UMTS mobile terminal, taking into account the size of the screen and/or the computing capacities and/or image processing means contained in the UMTS mobile terminal,
voice recognition means,
receiving means for receiving a request sent by the user from the UMTS mobile terminal;
the aim of the request being to obtain the information related to everyday life and linked with a gestural practice; the request having been formulated by the user
by entering data, particularly by a selection means and/or by a pointing means and/or by means of a keyboard associated with the UMTS mobile terminal, and/or
by using a voice operation;
the server additionally comprising, if the request is formulated in the form of a voice operation, said voice recognition means for recognizing the voice operation;
the server additionally comprising:
data processing means for processing the request;
selection means for selecting the short video sequence illustrating the gestural practice in the data base associated with the server as a function of the request and the display capacities of the UMTS terminal,
sending means for sending the short video sequences from the server to the UMTS mobile terminal, via the UMTS standard communications network.

23. Server in accordance with claim 22; the server being composed of a plurality of said secondary servers, which are identical, distinct, and connected either to one another or to a central server.

24. Server in accordance with one of the claims 22 or 23; the call processor comprising said computing means for computing and adapting the short video sequences as a function of the display capacities on the UMTS terminal.

25. Server in accordance with one of the claims 22 or 23; the call processor comprising said computing means for adapting, in real time, the sending rate and/or the computing and/or selection of the short video sequences as a function of the quantity of information received by the UMTS terminal, taking into account the performances of the telecommunications network; the performances being evaluated, in real time, by the call processor.

26. Said server in accordance with any of the claims 22 or 23; the server, from which the information related to everyday life and linked with a gestural practice is broadcast, being operated by a service provider in return for payments;
the server additionally comprising said computing means for processing the payments according to at least one of the two cases below:
(a) payment through an operator of the UMTS standard telecommunications network
if the users accesses the server through an operator of the UMTS standard telecommunications network and if the service provider has concluded a contract with the telecommunications operator,
the server additionally comprises:
computing means for supplying information, in real time, to the user, including the price that the telecommunications operator will add to the contractual device connecting the users to the telecommunications operator,
sending means for sending the short video sequence to the terminal of the user after the consent of the user has been received.
(b) direct payment by the user
if the user accesses the server through an operator of the UMTS standard telecommunications network and if the service provider has not concluded a contract with the telecommunications operator,
the server additionally comprises:
computing means for supplying information, in real time, to the user, including the price that the service provider will invoice to the user,
sending means for sending the short video sequence to the terminal of the user after the consent of the user has been received.

27. The server in accordance with any of the claims 22 or 23; the server additionally comprising image processing means for introducing technical and/or business data related to marketable goods and/or services within the short video sequences.

28. The server in accordance with claim 27; the server additionally comprising:
interactive image means using said UMTS standard telecommunications network to offer, via the UMTS mobile terminal, to the user, during the sending of the short video sequences and/or before or after the sending, the possibility of purchasing the goods or services, so that a business relationship may thus be established between the user and the supplier of the marketable goods and/or services.

29. The server in accordance with claim 28; the server additionally comprising:
computing means for informing the user, in real time, via the UMTS terminal, that the payments will be due by the user and/or the supplier of the marketable goods and/or services to the service provider, in return for the establishing of a business relationship,
computing means for posting payments due by the user and/or the supplier of the marketable goods and/or services to the service provider in return for establishing the business relationship.

30. The server in accordance with claim 28; the user having refused the sending of the short video sequences, comprising the establishing of a business relationship between the user and the supplier;
the server additionally comprising:
means for processing the refusal decision, particularly comprising said voice recognition means,
sending means for sending the short video sequence to the terminal of the user after the consent of the user has been received, comprising the establishing of a business relationship between the user and the supplier.

31. The server in accordance claim 28, such that the image processing means for introducing technical and/or business data related to goods and/or services within the short video sequences uses at least one of the means selected from among the following group of means:
(a) a superimposing means for superimposing images or a continuous set of images of a promotional or advertising nature in the form of visual and/or audio banners on the short video sequence,
(b) a insertion means for inserting one or more sequence in the short video sequence that only contain images or a continuous set of images of a promotional or advertising nature with or without audio comments,
(c) a showing means for showing or demonstrating the use of goods or services of a marketable nature by the images with audio comments or by a continuous set of images with audio comments in the short video sequence,
(d) a insertion means for inserting the trademark, logo, a marked product or any distinctive sign of a marketable product and/or service within the short video sequence in a clearly visible and audible manner.

32. The server in accordance with any of the claims 22 or 23, such that the duration of the short video sequences is at the most equal to 9 minutes.
